(19) United States
(12) Patent Application Publication
(10) Pub. No.: US 2023/0172203 A1
(43) Pub. Date: Jun. 8, 2023

(54) PLANT METABOLISM PROMOTING COMPOSITIONS AND METHODS OF USE

(71) Applicant: Panoptic Ag Solutions LLC, Bartow, FL (US)

(72) Inventors: Joshua Steinbronn, Winter Haven, FL (US); Bradley Maag, Lakeland, FL (US)

(73) Assignee: Panoptic Ag Solutions LLC, Bartow, FL (US)

(21) Appl. No.: 18/074,271

(22) Filed: Dec. 2, 2022

Related U.S. Application Data
(60) Provisional application No. 63/286,937, filed on Dec. 7, 2021.

(51) Int. Cl. A01N 37/46; C05C 11/00; A01P 21/00

(52) U.S. Cl. CPC A01N 37/46; C05C 11/00; A01P 21/00

(57) ABSTRACT

A plant metabolism promoting composition for promoting metabolic processes in plants includes an L-amino acid, or a salt or a derivative thereof, having a chemical formula of HO₂CCH(NH₂)CH₂CH₂CONHR, wherein R is an alkyl or an alkenyl. An amount of the composition applied to one or both of a seed and a plant is sufficient to augment one or more of: i. growth of a plant growing from the seed or growth of the plant, ii. health of a plant growing from the seed or health of the plant, iii. quality of yield from a plant growing from the seed or quality of yield from the plant, and iv. quantity of yield from a plant growing from the seed or quantity of yield from the plant.

### CROSS-REFERENCE TO RELATED APPLICATIONS

I hereby claim the benefit under 35 U.S.C. Section 119(e) of U.S. Provisional application 63/286,937 filed Dec. 7, 2021.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to metabolism regulating compositions and more particularly pertains to a new metabolism regulating composition for promoting metabolic processes in plants. In order to follow good environmental stewardship and improve plant yield, novel mechanisms to improve plant growth have been explored. Natural products that augment plant growth are preferred solutions to synthetic molecules, which can leave residues in plant tissues.

L-theanine is a naturally-occurring, non-proteogenic amino acid found in Camellia sinensis (commonly tea plant, tea shrub, or tea tree) and a single species of mushroom. L-theanine is produced enzymatically by theanine synthetase from L-glutamic acid and ethylamine. L-theanine accumulates in tea leaves in response to ammoniacal nitrogen fertilizer applications and is involved in giving tea its “umami” flavor. Exogenous application of L-theanine, or its structural analogue γ-glutamylmethylamide, can improve the quality and yield of tea plants by increasing the number of usable leaves.

Outside of Camellia sinensis, plants do not accumulate L-theanine in their tissues, suggesting L-theanine plays little or no role in their metabolism. Thus, it is remarkable and surprising that application of L-theanine to non-tea plant species dramatically improved plant growth, health, and both quality and quantity of yield. It therefore is unlikely that one skilled in the art would deduce from the literature that L-theanine would have any plant metabolism improvements outside of Camellia sinensis. It also is surprising that applications of L-theanine improved plant growth on agronomically important crops from seeds to mature trees, suggesting a novel mechanism for non-tea plants, regardless of application methodology: seed treatment, soil applications and foliage applications.

### (2) Description of Related Art Including Information Disclosed Under 37 CFR 1.97 and 1.98

The prior art relates to metabolism regulating compositions. JPH06256110A includes combinations comprising an amino acid, which can be L-theanine, a cytokinin, an auxin, and vitamins. Also claimed are methods for using the combinations to treat tea plants and plants for the purpose of improving umami taste. Most agronomically important crop species would not benefit from an improvement in umami taste but rather from improvements in plant growth and plant yield. As there are no examples of applications of the combinations to tea plants to improve plant growth, plant health, yield quality, or yield quantity, nor are any examples provided indicating that such applications to other agronomically important plants would elicit similar beneficial results, their use with any plants for the purposes of improving plant health, growth, yield quality, and yield quantity would be indeterminable without significant experimentation. Furthermore, there is neither anticipation nor suggestion that compositions comprising L-theanine without a cytokinin, an auxin, and vitamins would promote plant growth, health, and both quality and quantity of yield in agronomically important plants.

JPH06169642A teaches compositions comprising L-theanine, alanine, glycine, amino acids, nucleic acid oligosaccharides, an auxin, and a cytokinin along with methods for their use in promoting mitosis and hypertrophy when used with tea plants and leafy vegetables. A person skilled in the art would not deduce that the response came from L-theanine alone as the other components of the composition, such as the plant hormones auxin and cytokinin, would also elicit beneficial plant growth responses. As no examples of application of these combinations to other agronomically important plants were provided, their use in plants other than tea plants and leafy vegetables would only be possible with significant experimentation. Furthermore, the reference does not teach that compositions comprising L-theanine without alanine, glycine, amino acids, nucleic acid oligosaccharides, an auxin, and a cytokinin would promote plant growth, health, and both quality and quantity of yield in agronomically important plants.

JP2004168686A provides a foliar spray comprising one or more of L-theanine, glutamine, and glutamic acid, as well as methods of using the foliar spray a few days before harvest to increase the L-theanine content of tea leaves. As tea produces L-theanine and the other amino acids, this result is not surprising. This reference does not disclose methods for using the foliar spray to improve growth, health, and both quality and quantity of yield in agronomically important plants.

US Application Pub. No. 2021/188726 specifies water dispersible compositions comprising sulfur, at least one amino acid or derivative, and a surfactant, to improve the growth, strength, health, and nutritive value of crops, wherein the composition has a particle size in a range of 0.1-20 microns. This reference thus does not anticipate compositions comprising L-theanine, in the absence of sulfur and a surfactant, would improve growth, health, and both quality and quantity of yield in agronomically important plants.

CN111943767A and CN109824437A claim fertilizers comprising multiple components, one of which is compound amino acids. The compound amino acids may include theanine. It thus is not anticipated that compositions comprising L-theanine, in the absence of the other multiple components, would improve crop yields.

Similarly, CN108456115A and CN107805106A claim fertilizers comprising multiple components, one of which is L-theanine. It thus is not anticipated that compositions comprising L-theanine, in the absence of the other multiple components, would improve crop yields.

### BRIEF SUMMARY OF THE INVENTION

An embodiment of the disclosure meets the needs presented above by generally comprising an L-amino acid, or a salt or a derivative thereof, having a chemical formula of HO₂CCH(NH₂)CH₂CH₂CONHR, wherein R is an alkyl or an alkenyl. An amount of the composition applied to one or both of a seed and a plant is sufficient to augment one or more of:

i) the growth of a plant growing from the seed or growth of the plant;

ii) the health of a plant growing from the seed or health of the plant;

iii) the quality of yield from a plant growing from the seed or quality of yield from the plant; and

iv) the quantity of yield from a plant growing from the seed or quantity of yield from the plant.

The composition can be applied to seeds, roots, or foliage of a plant to promote one or more metabolic processes of the plant. Methods of application include seed treatment, application to soil at planting, application to soil during the growing season, foliar application, and fertigation. The compositions can be applied alone, or, for ease of application, combined with one or more of a fertilizer, an adjuvant, an oil, a fungicide, an insecticide, an herbicide, a plant growth regulator, a plant growth promoting organism, a seaweed, a humic acid, a fulvic acid, and the like.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings and images wherein:

FIG. 1 is a photo showing a representative untreated plant (left) and a representative L-theanine treated plant (right) from a 2021 York, NE Corn Replicated Field Trial.

FIG. 2 is a photo of representative samples of the untreated onions (left) and L-theanine treated onions (right) produced in a 2021 Pennsylvania Onion Replicated Field Trial.

FIG. 3 is a flow diagram for a method utilizing an embodiment of the disclosure.

### DETAILED DESCRIPTION OF THE INVENTION

An embodiment of the disclosure meets the needs presented above by generally comprising an L-amino acid, or a salt or a derivative thereof, having a chemical formula of HO₂CCH(NH₂)CH₂CH₂CONHR, wherein R is an alkyl or an alkenyl. R may comprise ethyl (such that the L-amino acid is L-theanine), methyl (such that the L-amino acid is γ-glutamylmethylamide), propyl, isopropyl, butyl, isoprenyl, or the like.

The plant metabolism promoting composition generally comprises a solvent into which the L-amino acid, or the salt or the derivative thereof, is substantially dissolved to achieve a concentration of the L-amino acid sufficient to promote a metabolic process in a plant. The solvent generally comprises water, but also may include cosolvents, such as, but not limited to, alcohols, dimethyl sulfoxide, and the like. The composition also may comprise one or more of a fertilizer, an adjuvant, an oil, a fungicide, an insecticide, an herbicide, a plant growth regulator, a plant growth promoting organism, a seaweed, a humic acid, a fulvic acid, and the like.

The plant metabolism promoting composition may be applied to one or both of a plurality of seeds and a plurality of plants by one or more application methods. These application methods include, but are not limited to, soaking the seeds, coating the seeds, spraying soil proximate to the plants at time of planting of the seeds, spraying soil proximate to the plants during the growing season, spraying foliage of the plants during the growing season, incorporating the composition onto dry fertilizer which then is applied to plants, and incorporating the composition into a fertilizer solution used for fertigation of the plants during the growing season.

An amount of the composition applied to one or both of a seed and a plant is sufficient to augment one or more of: i. growth of a plant growing from the seed or growth of the plant, ii. health of a plant growing from the seed or health of the plant, iii. quality of yield from a plant growing from the seed or quality of yield from the plant, and iv. quantity of yield from a plant growing from the seed or quantity of yield from the plant.

The plant metabolism promoting composition may be applied to the plurality of seeds and plants at a rate 0.1 g to 2000.0 g of the L-amino acid, or the salt or the derivative thereof, per acre. The plant metabolism promoting composition may be applied to the plurality of plants at a rate 10.0 g to 1000.0 g of the L-amino acid, or the salt or the derivative thereof, per acre. The plant metabolism promoting composition may be applied to the plurality of plants at a rate 25.0 g to 100.0 g of the L-amino acid, or the salt or the derivative thereof, per acre.

The plant metabolism promoting composition enables a method of promoting metabolism in a plant. The method comprises a first step of providing a plant metabolism promoting composition according to the specification above. A second step of the method is applying an amount of the plant metabolism promoting composition to one or both of a plurality of seeds and a plurality of plants sufficient to augment one or more of: i. growth of plants growing from the seeds or growth of the plants, ii. health of plants growing from the seeds or health of the plants, iii. quality of yield from plants growing from the seeds or quality of yield from the plants, and iv. quantity of yield from plants growing from the seeds or quantity of yield from the plants. The method may include an additional step of between one and twelve additional applications of the plant metabolism promoting composition to the plurality of plants during the growing season.

Provided below are detailed examples of the plant metabolism promoting compositions and methods for their use in greenhouse and replicated field trials. These examples should not be viewed as limiting in regard to compositions, methods, or plant species.
I. Definitions

CHK stands for check and represents the untreated control for a trial. LSD stands for least significant difference and C.V. stands for Coefficient of Variance. “a” denotes the corresponding value is significantly different from any other value that does not contain the letter “a”. Similarly, “b” denotes the corresponding value is significantly different from any other value that does not contain the letter “b”.
II. Greenhouse Trials

The base formulation used in greenhouse trials was an aqueous solution of L-theanine (20% by weight). The base formulation was further diluted with water as detailed for each trial.

A. 2021 Greenhouse Tomato Trial

Table 1 presents the results of this trial. Rutgers variety tomato plant seedlings (n=6/treatment) were planted in commercial potting soil and then were transplanted to 3 gallon pots. L-theanine treatment was applied at the equivalent of 1 pint in 100 gallons of water (125 ppm) and sprayed till runoff. Two treatment applications were made to the plants approximately 14 days apart.

Trial conclusions: Application of L-theanine increased basal diameter, plant height, and fruit count by 1.1 mm (+19.5%), 2.5 in (+13.3%), and 3.75 (+83.3%), respectively. The increase in early fruit production/yield is interesting because it points to the plant either accelerating its development and/or improving the nutrient content of the plant.

TABLE 1

| | | Basal | Plant | | |
|---|---|---|---|---|---|
| Treatment | Treatment | Diameter | Height | Leaf | Fruit |
| # | Composition | (mm) | (in) | (count) | (count) |
| 1 | CHK | 5.65 a | 18.75 a | 5 a | 4.5 b |
| 2 | L-theanine | 6.75 a | 21.25 a | 5 a | 8.25 a |
| LSD | | 1.393 | 4.947 | | 3.528 |
| P = 0.05 | | | | | |
| C.V. | | 10.0 | 11.0 | 0 | 24.6 |

B. 2021 Greenhouse Bell Pepper Trial

Table 2 presents the results of this trial. CalWonder variety pepper plant seedlings (n=4/treatment) were planted in commercial potting soil and then were transplanted to 3-gallon pots. L-theanine treatment was applied at the equivalent of 1 pint in 100 gallons of water (125 ppm) and sprayed till runoff. Two treatment applications were made to the plants approximately 14 days apart.

Trial conclusions: Application of L-theanine improved basal diameter and fruit count by 1.82 mm (+48.8%) and 3.0 (+120%), respectively. L-theanine dramatically increased stalk girth relative to the check and increased early fruit set, an important metric in continuously picked crop species like bell peppers.

TABLE 2

| | | Basal | Plant | |
|---|---|---|---|---|
| Treatment | Treatment | Diameter | Height | Fruit |
| # | Composition | (mm) | (in) | (count) |
| 1 | CHK | 3.73 b | 27 a | 2.5 b |
| 2 | L-theanine | 5.55 a | 26 a | 5.5 a |
| LSD | | 0.509 | 4.684 | 2.905 |
| P = 0.05 | | | | |
| C.V. | | 4.88 | 7.86 | 32.27 |

C. 2021 Greenhouse Spinach Trial

Table 3 presents the results of this trial. Whale variety spinach plant seedlings (n=6/treatment) were planted in commercial potting soil and then were transplanted to 3-gallon pots. L-theanine treatment was applied at the equivalent of 1 pint in 100 gallons of water (125 ppm) and sprayed till runoff. Two treatment applications were made to the plants approximately 14 days apart.

Trial conclusions: Application of L-theanine increased plant height and leaf count by 1.67 in (+23.9%) and 1 (+13.1%), respectively. Since leaves are the harvestable portion of spinach, increasing leaf count is the contributing factor to improved yield.

TABLE 3

| | | Basal | Plant | |
|---|---|---|---|---|
| Treatment | Treatment | Diameter | Height | Leaf |
| # | Composition | (mm) | (in) | (count) |
| 1 | CHK | 3.08 a | 7.0 b | 7.66 b |
| 2 | L-theanine | 3.07 a | 8.67 a | 8.66 a |
| LSD | | 0.784 | 1.271 | 0.677 |
| P = 0.05 | | | | |
| C.V. | | 17.17 | 10.93 | 2.85t |

D. 2021 Greenhouse Squash Trial

Table 4 presents the results of this trial. Butterbaby variety squash plant seedlings (n=4/treatment) were planted in commercial potting soil and then were transplanted to 3-gallon pots. L-theanine treatment was applied at the equivalent of 1 pint in 100 gallons of water (125 ppm) and sprayed till runoff. Two treatment applications were made to the plants approximately 14 days apart.

Trial conclusions: Application of L-theanine increased vine length and fruit per vine by 11.25 in (+25.7%) and 2.75 fruit (+183.3%), respectively. Application of L-theanine improved plant productivity, early flowering, and early fruit set.

TABLE 4

| | | Vine | |
|---|---|---|---|
| Treatment | Treatment | Length | Fruit/Vine |
| # | Composition | (in) | (count) |
| 1 | CHK | 43.75 a | 1.5 a |
| 2 | L-theanine | 55.00 a | 4.25 a |
| LSD | | 12.95 | 3.98 |
| P = 0.05 | | | |
| C.V. | | 11.66 | 61.49 |

E. 2021 Watermelon Trial

Table 5 presents the results of this trial. Seedless watermelon plant seedlings (n=4/treatment) were planted in commercial potting soil and then were transplanted to 3-gallon pots. L-theanine treatment was applied at the equivalent of 1 pint in 100 gallons of water (125 ppm) and sprayed till runoff. Two treatment applications were made to the plants approximately 14 days apart.

Trial conclusions: Application of L-theanine increased vine development by 14.5 cm (+39.7%) and average fruit per vine by 4.75 (100.0%).

TABLE 5

| | Treatment | Vine Length | Fruit/Vine |
|---|---|---|---|
| Treatment # | Composition | (cm) | (count) |
| 1 | CHK | 36.5 b | 4.75 b |
| 2 | L-theanine | 51.0 a | 9.50 a |
| LSD P = 0.05 | | 8.37 | 2.718 |
| C.V. | | 8.5 | 16.95 |

F. 2021 Zinnia Greenhouse Trial

Table 6 presents the results of this trial. Zinna seeds (n=6/treatment) were planted in commercial potting soil and then transplanted into 3-gallon pots. L-theanine treatment was applied at the equivalent of 1 pint in 100 gallons of water (125 ppm) and sprayed till runoff. Two treatments were made to the plants approximately 14 days apart.

Trial conclusions: Application of L-theanine increased basal diameter (mm), plant height (cm) and flower counts by 1.2 mm (+22.9%), 9.66 cm (+36.9%), and 6.0 (+143.9%), respectively, over the untreated check.

TABLE 6

| | Treatment | Basal Diameter | Plant Height | Flower |
|---|---|---|---|---|
| Treatment # | Composition | (mm) | (cm) | (count) |
| 1 | CHK | 5.25 b | 26.17 b | 4.17 |
| 2 | L-theanine | 6.45 a | 35.83 a | 10.17 |
| LSD P = 0.05 | | 0.715 | 4.952 | 3.384 |
| C.V. | | 8.23 | 10.76 | 31.82 |

G. 2021 Greenhouse Sunflower Trial

Table 7 presents the results of this study. Dwarf sunflower seeds (n=9/treatment) were planted in commercial potting soil in 1-gallon pots. Approximately 14 days after emergence, an L-theanine solution was applied to the foliage at the equivalent of 8 fl. oz./acre in 50 gallons of water (125 ppm) and sprayed till run off. One application was made.

Trial conclusions: Application of L-theanine increased the biomass (grams), root length (cm), root surface area (cm²) and root volume (cm³) of sunflowers by 4.4 grams (+12.8%), 70.5 cm, (+4.2%), 61.5 cm² (+14.3%), and 2.2 cm³ (+25.3%), respectively, over the untreated check.

TABLE 7

| | Treatment | Plant Biomass | Root Length | Root Surface | Root Volume |
|---|---|---|---|---|---|
| Treatment # | Composition | (g) | (cm) | Area (cm²) | (cm³) |
| 1 | CHK | 34.26 b | 1694.6 a | 429.6 a | 8.7 a |
| 2 | L-theanine | 38.63 a | 1765.1 a | 491.1 a | 10.9 a |
| LSD P = 0.05 | | 4.034 | 261.3 | 84.3 | 2.3 |
| C.V. | | 10.18 | 13.9 | 16.84 | 21.53 |

H. 2020 Greenhouse Corn Seed Treatment Trial

Table 8 presents the results of this trial. Corn seed (n=9/treatment) was treated with an aqueous solution of L-theanine at a rate of 1.0 fl. oz. per hundredweight of corn seed. The seeds were planted in commercial potting soil in 1-gallon pots. The plants were grown for 21 days before they were harvested.

Trial conclusions: Application of L-theanine as a seed applied treatment increased biomass (g), root length (cm) and root tips by 1.3 g (+4.4%), 69.1 cm (+7.0%), and 883.8 (+18.5%), respectively, over the untreated check. Of note is that root tips are the primary interface between the root and the soil and, generally speaking, increasing root tips will facilitate the increased uptake of both water and nutrients into the plant.

TABLE 8

| | Treatment | Plant Biomass | Root Length | |
|---|---|---|---|---|
| Treatment # | Composition | (g) | (cm) | Root Tips (#) |
| 1 | CHK | 28.62 a | 980.01 a | 4772.4 b |
| 2 | L-theanine | 29.88 a | 1049.08 a | 5656.2 a |
| LSD P = 0.05 | | 2.337 | 82.47 | 806.2 |
| C.V. | | 14.57 | 21.3 | 28.2 |

I. 2020 Greenhouse Soybean Seed Treatment Trial

Table 9 presents the results of this trial. Soybean seed (n=32/treatment) was treated with an aqueous solution of L-theanine at a rate of 1.0 fl. oz. per hundredweight of soybean seed. The seeds were planted in commercial potting soil in 1-gallon pots. The plants were grown for 21 days before they were harvested.

Trial conclusions: Application of L-theanine as a seed applied treatment increased biomass (g), root length (cm) and root tips by 0.43 g (+8.0%), 94.4 cm (+8.1%), and 763.4 (+21.0%), respectively, over the untreated check.

TABLE 9

| | Treatment | Plant Biomass | Root Length | Root Tips |
|---|---|---|---|---|
| Treatment # | Composition | (g) | (cm) | (count) |
| 1 | CHK | 5.37 a | 1169.3 b | 3628.6 b |
| 2 | L-theanine | 5.80 a | 1263.7 a | 4392.0 a |
| LSD P = 0.05 | | 0.435 | 65.3 | 343.1 |
| C.V. | | 6.86 | 10.52 | 16.76 |

J. 2021 Greenhouse Mustard Trial

Table 10 presents the results of this trial. Mustard seeds (n=28/treatment) were planted in commercial potting soil in 1-gallon pots. Approximately 14 days after seedling emergence, an aqueous L-theanine solution was mixed into water at a rate of 0.2 mL per 1000 mL water. The resulting solution was applied to the soil of the pots at a rate of 50 mL per plant. Plants were grown for an additional 14 days then harvested.

Trial conclusions: Soil application of L-theanine increased plant biomass (g), root length (cm) and root tips by 2.8 g (+14.5%), 120.9 cm (+28.5%), and 887 (+38.7%), respectively, above the untreated check.

TABLE 10

| | Treatment | Plant Biomass | Root Length | Root Tips |
|---|---|---|---|---|
| Treatment # | Composition | (g) | (cm) | (count) |
| 1 | CHK | 19.38 b | 424.6 b | 2291.7 b |
| 2 | L-theanine | 22.19 a | 545.5 a | 3178.7 a |
| LSD P = 0.05 | | 2.05 | 72.9 | 391.5 |
| C.V. | | 17.96 | 27.36 | 26.05 |

K. 2021 Greenhouse Soybean Trial

Table 11 presents the results of this trial. Soybean seeds (n=28/treatment) were planted in commercial potting soil in 1-gallon pots. Approximately 14 days after seedling emergence, an aqueous L-theanine solution was mixed into water at a rate of 0.2 mL per 1000 mL water. The resulting solution was applied to the soil of the pots at a rate of 50 mL per plant. Plants were grown for an additional 14 days then harvested.

Trial conclusions: Application of L-theanine increased soybean biomass (g) and root length (cm) by 1.3 g (+20.4%) and 66.4 cm (+4.2%), respectively, above the untreated check.

TABLE 11

| | Treatment | Plant Biomass | Root Length |
|---|---|---|---|
| Treatment # | Composition | (g) | (cm) |
| 1 | CHK | 6.18 b | 1565.0 a |
| 2 | L-theanine | 7.44 a | 1631.4 a |
| LSD P = 0.05 | | 0.761 | 115.6 |
| C.V. | | 20.38 | 13.19 |

L. 2021 Greenhouse Soybean Trial

Table 12 presents the results of this trial. Soybean seeds (n=12/treatment) were planted in commercial potting soil in 1 gallon pots. Approximately 14 days after emergence, an aqueous solution of L-theanine was applied to the foliage at a rate of 8 fl. oz./50 gallons of water (125 ppm) and sprayed till runoff. The plants were grown for another 14 days then harvested.

Trial conclusions: Application of L-theanine increased biomass (g), root length (cm), and root tips by 2.2 g (+20.1%), 254.6 cm (+13.2%), and 1345.1 (+36.1%), respectively, above the untreated check.

TABLE 12

| | Treatment | Plant Biomass | Root Length | Root Tips |
|---|---|---|---|---|
| Treatment # | Composition | (g) | (cm) | (count) |
| 1 | CHK | 10.84 a | 1931.2 a | 3730.8 b |
| 2 | L-theanine | 13.02 a | 2185.8 a | 5075.9 a |
| LSD P = 0.05 | | 2.291 | 355.76 | 911.33 |
| C.V. | | 21.11 | 19 | 22.75 |

M. 2021 Greenhouse Corn Trial

Table 13 presents the results of this study. Corn seed (n=14/treatment) was planted in commercial potting soil in 3-gallon pots. Approximately 14 days after emergence, an aqueous solution of L-theanine was applied at a rate of 0.2 mL (Treatment 2) and 0.4 mL (Treatment 3) per 1000 mL water. The resulting solutions were drenched at a rate of 50 mL per pot. The plants were grown for an additional 21 days then harvested.

Trial conclusions: Application of L-theanine to corn plants at two different rates changed biomass and root length by 9.0 grams (+13.9%) and −106.8 (−6.0%), respectively for Treatment 2 and 9.1 grams (+14.1%) and 65.3 (+3.6), respectively, for Treatment 3 above the untreated check. Interestingly, the higher rate of L-theanine not only improved the biomass of the plant, it also stimulated additional root growth over both the untreated and the lower rate of L-theanine.

TABLE 13

| | Treatment | Plant Biomass | Root Length |
|---|---|---|---|
| Treatment # | Composition | (g) | (cm) |
| 1 | CHK | 64.96 b | 1790.6 a |
| 2 | L-theanine | 74.0 a | 1683.8 a |
| | (8 fl. oz./acre) | | |
| 3 | L-theanine (16 | 74.1 a | 1855.9 a |
| | fl. oz./acre) | | |
| LSD P = 0.05 | | 6.663 | 220 |
| C.V. | | 9.39 | 16.33 |

III. Replicated Field Trials

A. 2021 York, NE Corn Replicated Field Trial

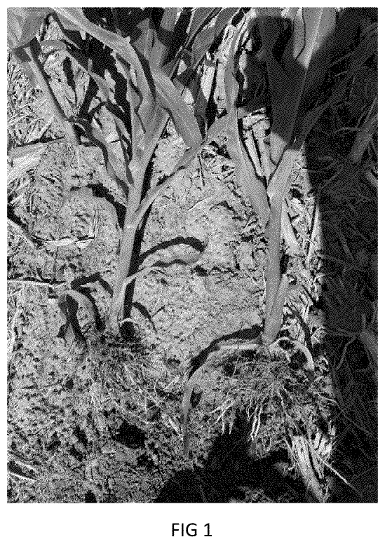

FIG. 1 is a photo from a 2021 York, NE Corn Trial. An aqueous solution of L-theanine was applied to the corn as an in-furrow application at a rate of 8 fl. oz. per acre. The pictures from the trial were taken at the V5 (5th Leaf) growth stage.

Trial conclusions: FIG. 1 is a photo showing a representative untreated plant (left) and a representative L-theanine treated plant (right). The L-theanine treated plant shows increases in root biomass development and stalk girth.

B. 2021 Pennsylvania Onion Replicated Field Trial

Table 14 presents the results of this study. Onions were maintained under grower standard practices. Four replications were performed per treatment. In this trial, applications of L-theanine were performed every 14 days for a total of 4 applications.

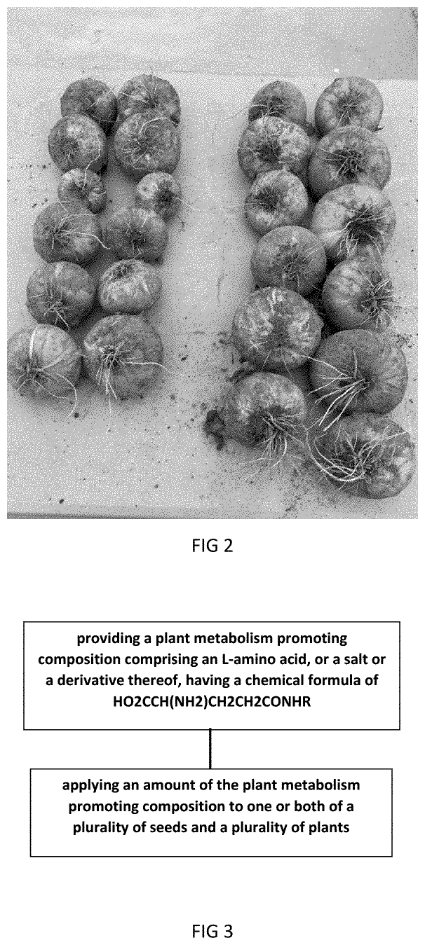

Trial conclusions: Application of L-theanine increased biomass of the onions by 75.0 g (49.3%). FIG. 2 is a photo of representative samplings of the untreated onions (left) and L-theanine treated onions (right) produced in this trial. Notable is the increase in size and uniformity for the treated onions over the untreated onions.

TABLE 14

| | Treatment | Fresh Onion |
|---|---|---|
| Treatment # | Composition | Mass (g) |
| 1 | CHK | 152 b |
| 2 | L-theanine | 227 a |
| LSD P = 0.05 | | 13.8 |
| C.V. | | 8.09 |

C. 2021 New York Replicated Apple Field Trial

Table 15 presents the results of this field trial. Mature apple trees (n=6) were treated with a 20% aqueous L-theanine solution at 1 pint per acre with application timings at Pink Bud, Bloom, Petal Fall, and every 2 weeks from Petal Fall until harvest.

Trial Conclusions: Applications of L-theanine increased salable yield by 93.1 bushels/acre (12.5%; 1 bushel=48 lbs), increased salable yield (a measure of fruit quality) , and reduced the number of defective fruits.

TABLE 15

| | Treatment | Salable Yield | Defects | Total Yield |
|---|---|---|---|---|
| Treatment # | Composition | (bu/acre) | (bu/acre) | (bu/acre) |
| 1 | CHK | 744.7 b | 156.0 a | 900.6 a |
| 2 | L-theanine | 837.8 a | 114.5 a | 952.3 a |
| LSD P = 0.05 | | 41.7 | 47.8 | 62.6 |
| C.V. | | 3.55 | 23.81 | 4.55 |

D. 2022 Replicated California Cherry Trial

Table 16 presents the results of this field trial. Mature cherry trees (n=6) were treated with a 10% aqueous L-theanine solution at 1 pint per acre with application timings at Early Bloom, Petal Fall, and Early Fruit set. The trial was maintained at grower standard fertilizer and pest management throughout the course of the trial.

Trial Conclusions: Applications of L-theanine increased yield by 12.8 boxes/acre (22.3%) over the untreated check.

| | Treatment | Yield |
|---|---|---|
| Treatment # | Composition | (Boxes/Acre) |
| 1 | CHK | 57.5 b |
| 2 | L-theanine | 70.3 a |
| LSD P = 0.05 | | 10.5 |
| C.V. | | 11.08 |

E. 2021 Replicated California Almond Trial

Table 17 presents the results of this trial. Almond trees (n=6) were treated with a 20% aqueous solution of L-theanine at 1 pint per acre at pink bud and full bloom. Additional applications at 0.5 pint per acre soil were applied at petal fall, petal fall +3 weeks, and petal fall +6 weeks for a total of applications. The trial was maintained at grower standard fertilizer and pest management throughout the course of the trial.

Trial Conclusions: Application of L-theanine increased almond yield by an average of 15.3 lbs per tree (11.2%).

TABLE 17

| | Treatment | Yield |
|---|---|---|
| Treatment # | Composition | (lbs/tree) |
| 1 | CHK | 136.9 b |
| 2 | L-theanine | 152.2 a |
| LSD P = 0.10 | | 13.02 |
| C.V. | | 7.75 |

F. 2021 Replicated Nebraska Soybean Field Trial

Table 18 presents the results of this trial. Soybean seeds (Glycine max) were planted at a rate of 150,000 seeds per acre. The treated plot size was 5 ft×40 ft and this was replicated 4 times. A 20% aqueous L-theanine solution was applied to the foliage at 8 fl. oz./acre at the R2 (full flowering) growth stage. The trial was fertilized and maintained under grower standard practices.

Trial Conclusions: Application of L-theanine increased yield by 6.0 bushels per acre (7.6%) over the untreated control.

TABLE 18

| | Treatment | Yield |
|---|---|---|
| Treatment # | Composition | (Bushels/Acre) |
| 1 | CHK | 78.6 b |
| 2 | L-theanine | 84.6 a |
| LSD P = 0.05 | | 5.23 |
| C.V. | | 2.85 |

E. 2022 Replicated South Dakota Spring Wheat Field Trial

Table 19 presents the results of this trial. Wheat seed (Triticum aestivum) was planted at a rate of 90 lbs/acre. The treated plot size was 5 ft×40 ft and this was replicated 4 times. A 20% L-theanine solution was applied at 8 fl. oz./acre to the foliage of the wheat approximately 40 days after emergence. The trial was fertilized and maintained under grower standard practices.

Trial Conclusions: Application of L-Theanine increased yield by 5.3 bushels/acre (10.9%) over the untreated control.

TABLE 19

| | Treatment | Yield |
|---|---|---|
| Treatment # | Composition | (Bushels/Acre) |
| 1 | CHK | 48.6 b |
| 2 | L-theanine | 53.9 a |
| LSD P = 0.05 | | 4.86 |
| C.V. | | 4.22 |

Although the foregoing invention has been described in some detail by way of illustration and example for purposes of clarity and understanding, it will be readily apparent, in light of the teachings of this invention, that certain changes and modifications may be made thereto without departing from the spirit or scope of the following claims.

Therefore, the foregoing is considered as illustrative only of the principles of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A plant metabolism promoting composition comprising:
an L-amino acid, or a salt or a derivative thereof, having a chemical formula of HO₂CCH(NH₂)CH₂CH₂CONHR, wherein R is an alkyl or an alkenyl, wherein an amount of the composition applied to one or both of a seed and a plant is sufficient to augment one or more of:
growth of a plant growing from the seed or growth of the plant;
health of a plant growing from the seed or health of the plant;
quality of yield from a plant growing from the seed or quality of yield from the plant; and
quantity of yield from a plant growing from the seed or quantity of yield from the plant.

2. The plant metabolism promoting composition of claim 1, wherein R is ethyl or methyl.

3. The plant metabolism promoting composition of claim 1, wherein the plant metabolism promoting composition comprises a solvent.

4. The plant metabolism promoting composition of claim 3, wherein the solvent comprises water.

5. The plant metabolism promoting composition of claim 3, further including the plant metabolism promoting composition comprising one or more of a fertilizer, an adjuvant, an oil, a fungicide, an insecticide, an herbicide, a plant growth regulator, plant growth promoting organism, a seaweed, a humic acid, and a fulvic acid.

6. A method of promoting metabolism in a plant, the method comprising the steps of:
providing a plant metabolism promoting composition comprising an L-amino acid, or a salt or a derivative thereof, having a chemical formula of HO₂CCH(NH₂)CH₂CH₂CONHR, wherein R is an alkyl or an alkenyl; and
applying an amount of the plant metabolism promoting composition to one or both of a plurality of seeds and a plurality of plants sufficient to augment one or more of:
growth of plants growing from the seeds or growth of the plants;
health of plants growing from the seeds or health of the plants;
quality of yield from plants growing from the seeds or quality of yield from the plants; and
quantity of yield from plants growing from the seeds or quantity of yield from the plants.

7. The method of claim 6, wherein:
the plant metabolism promoting composition comprises an aqueous solution of the L-amino acid, or the salt or the derivative thereof; and
the plant metabolism promoting composition is applied by one or more of:
coating the seeds;
soaking the seeds;
spraying soil proximate to the plants at time of planting of the seeds;
spraying soil proximate to the plants during the growing season;
spraying foliage of the plants during the growing season;
incorporation of the plant metabolism promoting composition into a dry fertilizer and applying it to seeds or plants; and
incorporation of the plant metabolism promoting composition into a fertilizer solution used for fertigation of the plants during the growing season.

8. The method of claim 7, further including an additional step of between one and five additional applications of the plant metabolism promoting composition to the plurality of plants during the growing season.

9. The method of claim 7, wherein R is ethyl or methyl.

10. The method of claim 7, wherein the plant metabolism promoting composition is applied to the plurality of plants at a rate 0.1 g to 2000.0 g of the L-amino acid, or the salt or the derivative thereof, per acre.

11. The method of claim 10, wherein the plant metabolism promoting composition is applied to the plurality of plants at a rate 10.0 g to 1000.0 g of the L-amino acid, or the salt or the derivative thereof, per acre.

12. The method of claim 11, wherein the plant metabolism promoting composition is applied to the plurality of plants at a rate 25.0 g to 100.0 g of the L-amino acid, or the salt or the derivative thereof, per acre.

13. A plant or a seed treated with the plant metabolism promoting composition according to the method recited in claim 7.
